(19) United States
(12) Patent Application Publication
(10) Pub. No.: US 2025/0300722 A1
(43) Pub. Date: Sep. 25, 2025

(54) Allocation of Satellite-Terrestrial Communication Compensation Among Downlink Compensation and Uplink Compensation

(71) Applicant: Lynk Global, Inc., Falls Church, VA (US)

(72) Inventors: Tyghe Robert Speidel, Washington, DC (US); Tomohiro Arakawa, Alexandria, VA (US)

(21) Appl. No.: 19/088,482

(22) Filed: Mar. 24, 2025

Related U.S. Application Data
(60) Provisional application No. 63/569,457, filed on Mar. 25, 2024.

(51) Int. Cl. H04B 7/185; H04W 84/06

(52) U.S. Cl. CPC H04B 7/18513; H04W 84/06

(57) ABSTRACT

Satellite-terrestrial communications according to particular protocols when signal propagation delays exceed design assumptions of the particular protocols, such as when an orbital base station communicates with a terrestrial user equipment (UE), might be addressed as described herein. This can involve dynamic compensation for frequency shift, catered to a cell median Doppler contour, (2) a first dynamic compensation for delay and delay rate of change, on a downlink signal only, catered to a weighted centroid (e.g., geographical median) delay rate of change contour, and (3) a second dynamic compensation for delay and delay rate of change, on an uplink signal only, catered to the remaining round-trip delay not yet accounted for by the first dynamic compensation for delay and delay rate of change used on the downlink.

### CROSS-REFERENCES TO PRIORITY AND RELATED APPLICATIONS

This application is a non-provisional of, and claims the benefit of and priority from, U.S. Provisional Patent Application No. 63/569,457 filed Mar. 25, 2024, entitled “Allocation of Satellite-Terrestrial Communication Compensation Among Downlink Compensation and Uplink Compensation”.

This application incorporates by reference, for all purposes:

U.S. Pat. No. 10,084,535, issued Sep. 25, 2018, and entitled “Method and Apparatus for Handling Communications Between Spacecraft Operating in an Orbital Environment and Terrestrial Telecommunications Devices That Use Terrestrial Base Station Communications” (Speidel I).

The entire disclosure(s) of application(s)/patent(s) recited above is (are) hereby incorporated by reference, as if set forth in full in this document, for all purposes.

### FIELD

The present disclosure generally relates to satellite-terrestrial communications and more particularly to handling communications according to particular protocols when signal propagation delays and/or Doppler shifts exceed design assumptions of the particular protocols, such as when an orbital base station communicates with a terrestrial user equipment (UE).

### BACKGROUND

Mobile communication devices, and more generally, user equipment (UE), communicate with one or more base stations to allow data/voice/video/text/etc. to flow between the UE and remote systems, such as Internet-connected servers, equipment, other user equipment, etc. The communication follows a particular protocol or protocols so that a UE expects, is programmed for, and/or is configured so that the UE can communicate with a base station. Many wireless communication protocols have been implemented and have become standards such that devices programmed and configured to operate consistent with a given protocol can communicate. Examples of standard protocols include the Global System for Mobile Communications (GSM) protocol, the Universal Mobile Telecommunications Service (UMTS) protocol, the Long-Term Evolution (LTE) protocol, the 5G protocol, the 5G NTN protocol, and future xG or xG NTN protocols, and/or the like. These protocols might be defined by standardization bodies such as the 3rd Generation Partnership Project (3GPP). The wireless communication protocols can provide reliable wireless connectivity to the mobile devices, typically under certain design assumptions. The description herein might apply to other wireless communication protocols and standards not specifically called out.

A base station might be a terrestrial cellular telephone tower that is configured and/or programmed to communicate according to a particular protocol. An example might be a base station that might be referred to herein as an “eNB” that is an “ENodeB” or “E-UTRAN Node B”, which is short for “Evolved Node B” that includes hardware, software, and/or firmware of a base station that communicates using the LTE protocol. The description herein might apply to other protocols besides LTE, which is used here as an example.

A given protocol might have been developed with certain design assumptions. For example, a protocol might assume a maximum length of a text message, a symbol length (and/or a minimum or maximum length), a packet size (and/or a minimum or maximum size), a particular format for a telephone number, that a base station is stationary, that a UE is travelling at less than some maximum speed relative to the ground (e.g., the surface of the Earth) and relative to the base station, that the distance between the base station and the UE is less than a maximum design distance, etc. A given protocol might then be considered to have some limitations in its operating conditions.

As examples, an air interface between a UE and an eNB may operate well enough if the UE and the eNB are within a certain distance that is limited by design assumptions of the protocol used for that air interface and are moving relative to each other at less than some speed (and the corresponding Doppler shift) that is limited by other design assumptions of the protocol. In some protocols, timing and speed limitations are derived from the protocol itself and directly tied to frequency/time frame structure, RACH window size, and corresponding timing advance limits (e.g., 0.67 milliseconds (ms) in LTE). In many air interface protocols used with terrestrial cellular devices and other UEs designed to connect with terrestrial base stations, the Doppler and delay limitations might require distances and speeds to be below what is needed for satellite base stations, which must be sufficiently far from the surface of the Earth and moving at a high enough speed to remain in orbit.

In some approaches, UEs are modified or adapted to accommodate satellite-based communications. In others, such as those shown in Speidel I, satellite-based eNBs can be configured to communicate with terrestrial UEs without requiring modifications to the terrestrial UEs, despite the air interfaces being over greater distances (and resulting delays due to the speed of light) and greater relative speeds (and resulting Doppler shifts) that contemplated in the protocols in use by the terrestrial UEs.

A protocol might take into account that signals sent are not guaranteed to be received correctly as sent and thus might specify how a device is to convey to another device that signals/data/etc. are received correctly, not received, or received but with errors. For example, a protocol might specify how a device sends an acknowledgement of successful receipt of a packet or other unit of data (an “ACK”), a message indicating failed receipt of a packet or other unit of data (a “NACK”), a request for repeat transmission of a unit of data (“ARQ”), and various other handshaking, error recovery, confirmation, and control messaging. In many cases, a protocol specifies messaging and interpretation of data and signals using a network layer approach, such as the Open Systems Interconnection (OSI) model's seven-layer networking convention.

### SUMMARY

Satellite-terrestrial communications according to particular protocols when signal propagation delays and/or Doppler shifts exceed design assumptions of the particular protocols, such as when an orbital base station communicates with a terrestrial user equipment (UE), might be addressed as described herein. This can involve dynamic compensation for frequency shift, catered to a cell median Doppler contour, (2) a first dynamic compensation for delay and delay rate of change, on a downlink signal only, catered to a weighted centroid (e.g., geographical median) delay rate of change contour, and (3) a second dynamic compensation for delay and delay rate of change, on an uplink signal only, catered to the remaining round trip delay not yet accounted for by the first dynamic compensation for delay and delay rate of change used on the downlink.

Disaggregation of the dynamic compensation for delay and delay rate of change on uplink signals and downlink signals individually and independently has some advantages. For example, this technique allows for the substantial improvement of signal integrity and synchronization of the downlink frame structure; this can be advantageous for this type of technology because it leverages standard, unmodified, existing 3GPP compliant terminals/devices. In many instances, the more that the signals received by UEs or other devices can be made to look stationary from the perspective of delay, delay rate of change, Doppler, and Doppler rate of change, the more likely the system will function better.

In can be that some particular dynamic compensation is done for a first link and different dynamic compensation is done for a second link, where the first link is an uplink and the second link is a downlink, or where the first link is a downlink and the second link is an uplink. Thus, the compensation might be for frequency shift and dynamic compensation for delay and delay rate of change for a first link and frequency shift and dynamic compensation for delay and delay rate of change on a second link.

In communications described herein, there might be communication between a base station or other equipment housed in a satellite and a terrestrial UE, which might be a mobile device that is configured to expect and to process certain communications according to a prespecified protocol, such as a protocol that is used for mobile device communications with terrestrial base stations. Communications with a satellite versus terrestrial base station is different, given different communication constraints. There can be a number of communication constraints, such as limits on how low a satellite can orbit and how fast it must be moving to remain in its orbit. Such communication constraints might require exceeding design assumptions of particular protocols that the UE expects and that it uses. A base station in orbit can compensate for one or more communication constraint so that the UE does not see unexpected communications signals.

Some of the compensation that a base station performs might by dynamic and might change over time as communication conditions change. A communication condition can be some effect on signals between the base station and a UE. For example, signals between an orbital base station and a UE might have a communication condition of a Doppler frequency shift or a delay. The base station might effect a compensation to adjust for Doppler frequency shift based on a relative velocity between the orbital base station and a UE and that adjustment might change as the relative velocity changes. In many cases, the orbital base station can compute ahead of time the relative velocity and its changes over time. The communication conditions that the orbital base station considers when making a compensation might include frequency shifts, rates of change of frequency shift, delays, rates of change of delay, etc. and dynamic compensation might be applied to signals sent by the orbital base station or adjusted for in signals received by the orbital base station.

An orbital base station might have information indicating a terrestrial region the orbital base station is presently supporting. The terrestrial region might be referred to as a “cell” and the cell might have an area or volume that is sufficiently large that, at least for some period of time during the satellite's travel, the communication conditions vary over the cell. But one example is that a distance from the orbital base station to a UE can vary depending on where in the cell the UE is located. As such, the corresponding communication condition, such as the delay given that signals travel at a finite speed, would vary over the cell. The base station might track, compute, and/or sample values, or expected values, of each of a plurality of communication conditions over the cell. For example, the base station might compute what frequency shifts are expected for UEs at various locations with a cell being presently serviced by the base station.

A protocol might allow for some variance in communication conditions, such as accommodating small timing shifts and frequency shifts. The base station might be programmed to be aware of those allowed variances and can then apply dynamic compensation such that signals are received and/or perceived by the UE to be possibly varying, but still within allowed variances, as if the signals were being exchanged with what the UE would typically experience with a stationary, terrestrial base station. As explained herein, dynamic compensation might be provided for a round-trip communication with the dynamic compensation partitioned into a downlink portion and an uplink portion, with those two not necessarily being the same but that generally combine to provide needed overall dynamic compensation. In some cases, the dynamic compensation is aligned with compensation associated with a cell median value for the communication condition being compensated for, or might be aligned with compensation associated with a cell center. For example, the base station might adjust for a delay determined from a distance from the satellite to a center point of the cell (e.g., geographic center, weighted centroid, etc.) or a median distance over the range of distances within the cell. Thus, the base station might use a first dynamic compensation on a downlink signal only and a second dynamic compensation on an uplink signal only, with the second dynamic compensation computed such that dynamic compensation over the round trip is fully accounted for.

Disaggregation of the dynamic compensation for some communication condition on uplink signals and downlink signals individually and independently has some advantages, as explained herein. In can be that some particular dynamic compensation is done for a first link and different dynamic compensation is done for a second link, where the first link is an uplink and the second link is a downlink, or where the first link is a downlink and the second link is an uplink. Thus, the compensation might be for frequency shift and dynamic compensation for delay and delay rate of change for a first link and frequency shift and dynamic compensation for delay and delay rate of change on a second link.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of methods and apparatus, as defined in the claims, is provided in the following written description of various embodiments of the disclosure and illustrated in the accompanying drawings.

### BRIEF DESCRIPTION OF THE DRAWINGS

Aspects of the present disclosure might be best understood from the following detailed description when read with the accompanying figures.

FIG. 1 illustrates how a ground track overpass of a cell might occur from a satellite-based eNB.

FIG. 2 illustrates uncompensated one-way delay in milliseconds (ms) and one-way delay rate of change in symbols per second (sps) for the entirety of a cell such as the cell illustrated in FIG. 1.

FIG. 3 illustrates uncompensated downlink carrier frequency shift (in kHz) and downlink carrier frequency shift rate of change (in Hz per second) for the entirety of a cell such as the cell illustrated in FIG. 1 and represented in FIG. 2.

FIG. 4 illustrates a terrestrial base station implementation that does not have a timeslot offset between Tx and Rx frames with respect to some reference, t_{ref}:

FIG. 5 illustrates dynamic timeslot offsets τ_{dn}(t) and τᵤₚ(t) for the Tx and Rx frames, respectively, with respect to some reference t_{ref} that might be used for a fast-moving and distant base station (e.g., an orbiting base station), where a sum of τ_{dn}(t) and τᵤₚ(t) is equal to a minimum round-trip delay between the base station and the nearest point on some intended area or volume of service.

FIG. 6 illustrates dynamic downlink and uplink time slot offset compensation for the overpass illustrated in FIG. 1, where the dynamic downlink time slot offset and dynamic uplink time slot offset compensation are done for each of their respective portions of the round-trip delay.

FIG. 7 illustrates the compensated residual uplink delay (in ms) and compensated residual one-way delay rate of change (in symbols per second) for the entirety of the cell illustrated in FIG. 1, using the compensation technique in FIG. 6.

FIG. 8 illustrates dynamic downlink and uplink time slot offset compensation for the overpass illustrated in FIG. 1.

FIG. 9 illustrates compensated residual uplink delay (in ms) and compensated residual one-way delay rate of change (in symbols per second) for the entirety of the cell illustrated in FIG. 1, using the compensation technique shown in FIG. 8.

FIG. 10 illustrates residual frequency offset, and residual frequency offset rate of change over the course of the overpass based on a nominal frequency offset compensation by the base station.

FIG. 11 illustrates an example computer system memory structure as might be used in performing methods described herein, according to various embodiments.

FIG. 12 is a block diagram illustrating an example computer system upon which the systems illustrated in various figures described here might be implemented, according to various embodiments.

### DETAILED DESCRIPTION

In the following description, specific details are set forth describing some examples consistent with the present disclosure to provide a thorough understanding of the teachings herein. It will be apparent, however, to one skilled in the art that some examples may be practiced without some or all of these specific details. Well-known features may be omitted or simplified in order not to obscure the examples being described. The specific examples disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one example may be incorporated into other examples unless specifically described otherwise or if the one or more features would make an example non-functional.

The present disclosure describes methods and apparatus for handling communications according to various protocols that have design assumptions where the communications is outside those design assumptions. Examples might include communications having a large and dynamic signal propagation delay, Doppler shift, signal delay spread, and Doppler spread on an air interface between unmodified standard terrestrial UEs within a cell, or area, of coverage, and a serving satellite-based eNB using standard protocols, such as the 3GPP protocols; 2G, 3G, 4G, 5G, etc. The dynamic quantities might be changing with relative time, position, velocity, etc.

Uplink and downlink frame structures might be dynamically offset to independently offset a portion of the round-trip time delay. The round-trip time delay is often equal to around the uplink delay plus the downlink delay and those two delays might or might not be equal. Approaches described herein can ameliorate the need for adjustments in a terrestrial UE despite the delays being longer than design assumptions of the protocols in use. As used herein, descriptions of “areas” such as areas of coverage can be interpreted to apply to volumes, such as a volume of coverage that might take into account three-dimensional volumes of coverage. The three-dimensional volume might be expressed as an area, such as a footprint on the surface of the Earth, with the understanding that the volume is that surface area extended or swept over some applicable altitude. In a specific example, to say that a building is in an area of coverage can, depending on context, be extended to mean that coverage is provided at the ground floor and elsewhere in the general volume of the building.

In some implementations of such an air interface, communication can conform to terrestrial deployments from both a Core Network (CN) and a Radio Access Network (RAN) perspective. As such, from the RAN side, satellite-based cells that remain static relative to the Earth, despite the motion of the satellite base station, might be preferred. For example, there might be a prescribed location (e.g., GPS location, latitude/longitude, etc.) and cell radius around that location (e.g., 100 km, 75 km, 50 km) and the satellites in the space network are configured to place a beam on that location and track it as it flies in orbit. During the time that the cell is serviced by a beam, all UEs within that beam might be provided with functional service through that satellite. The cell might also take the form of a shaped polygon, and/or some other shape or size of cell/beam that might be serviced by some antenna of any shape, size, and radiation/beam pattern.

Across the span of a cell, the magnitude of the Doppler and delay dynamics typically are not constant. Four main effects of Doppler and delay on the air interface are (1) frequency shift (Hz), (2) frequency shift rate of change (Hz/s), (3) delay (in symbols(s), or could be in bits), and (4) delay rate of change (symbols/second (s/s) or could be in bits/second (bits/s)). These effects can be zeroed out at a particular location within the cell or some location that is not within the cell and might be relative to the cell. For instance, as described in Speidel I, the point in the cell that is the closest to the satellite might be zeroed out and the rest of the cell would have what could be described as “residual” frequency offset, “residual” frequency offset rate of change, “residual” delay, and “residual” delay rate of change. Furthermore, as the satellite flies in orbit, a location within the cell that is closest to the satellite might be a moving location within the cell or on the cell edge, depending on elevation and azimuth angle of the satellite relative to the cell. As a result, handling compensations for those effects without requiring modifications to UEs might be needed and/or desired, as described herein.

Using a dynamic time slot offset and having the downlink and the uplink compensating for different and non-equal portions of the round-trip delay can result in cleaner signal drift (or less signal drift) on the downlink that a UE has to deal with.

The methods and apparatus described herein can be implemented across a suite of orbits, cell sizes, etc. but for the sake of examples, specific orbits and other details might be referenced herein, with the understanding that the teachings herein could be easily applied to other implementations. This is inclusive of orbits around Earth, such as Low Earth Orbits (LEOs), Medium Earth Orbits (MEOs), High Earth Orbits (HEOs), Geosynchronous Earth Orbits (GEOs), inclined orbits (e.g., Molniya orbits), as well as orbits around other celestial bodies (Moon, Mars, etc.) as applicable in context.

In one specific example for the purposes of illustration, an orbit has an altitude of 550 km, the orbit is approximately circular, the orbit is approximately 97.6 degrees inclined relative to the equator, and the orbit has a 12 PM Longitude of the Ascending Node (LTAN), but other orbits at altitudes suitable for orbiting and different inclinations and LTAN might be deployed. The example orbit might be referred to herein as a “12 AM/12 PM Sun Synchronous Orbit (SSO) in Low Earth Orbit (LEO).”

Given this example orbit for a satellite that might house an eNB, consider a cell on the surface of Earth (or approximately on the surface, providing service to devices relatively near the surface of the Earth, such as on the ground, in an excavation, in a building, on an airplane in the atmosphere, etc.) with a radius of 100 km centered about an arbitrary location, P, on the surface of Earth and further consider a trajectory of the orbit for some period of time, such as around seven days. This results in a series of overpasses of the cell by a satellite in that orbit that have variable geometries and therefore variable dynamics in delay and Doppler contours that can be handled as described herein. The examples herein can be extended to cells that are not entirely circular or even ovals, but for the purposes of illustration and example, a circular cell might be easy to understand. A simulation or computation could be performed to determine what these orbital details might be.

First, consider an overpass that is as close as possible to flying directly overhead of P at the center of the 100 km radius cell (e.g., an overpass that peaks at approximately 90 degrees elevation angle). The geometry of this scenario is such that the overpass is where the largest magnitudes and rates of change in delay and Doppler occur over the course of the pass. Assume the satellite's ground track traverses through, or over, the cell. As a result, the minimum distance to the cell actually remains constant (or nearly so), or at least equal to the altitude of the satellite (which remains nearly constant, or nearly so), for a period while the satellite overflies the cell itself. The point on the Earth that is the minimum distance to the cell can move rapidly across the cell, initially as a point on the cell edge and then as a point within the cell, not necessarily at the center, and then again as a point on the edge on another, maybe opposite, side of the cell from where it started.

While only high elevation passes will have a minimum point that lands within the cell at some point during the pass, the motion of the minimum point itself is not unique to high elevation overpasses. Even an overpass where the satellite ground track does not go through the cell will have a minimum distance to the cell that is represented by a location on the edge of the cell that might move around the edge. For instance, if a satellite overpasses a cell from North to South in the Western side of the sky, the initial minimum distance point on the cell would be a cell edge location toward the northwest and as the satellite moves through the overpass, the minimum distance point would move along the edge down toward the southwest edge of the cell.

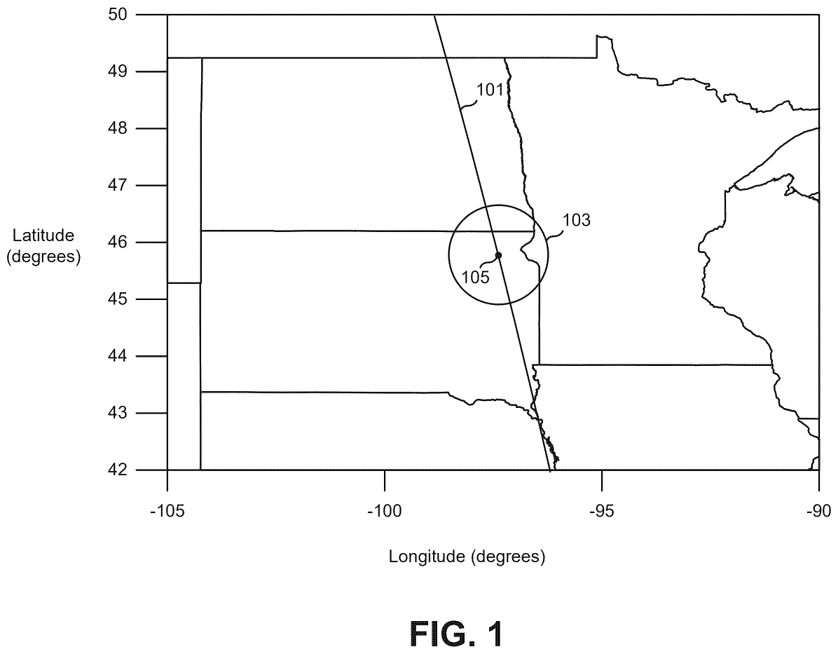

FIG. 1 provides an illustration of such an overpass of a satellite, a cell serviced by that satellite, and a ground track of the satellite. The overpass is indicated by a ground track 101 of the orbit and the cell 103 is shown by its cell edge, with a cell center 105 therein. In this example, the cell center is within the border of the state of South Dakota, United States. The orbit might be a 550 km altitude SSO orbit that has ground track 101 as shown, which happens to overpass the cell in a manner that is directly overhead (resulting in approximately 90-degree peak elevation angle). This is indicated by ground track 101 intersecting cell center 105.

Cell 103 might be represented in memory, software, and/or a simulation by a mesh of random, or nonrandom (e.g., uniformly distributed by surface area) points at which the simulation might determine a distribution or spread of (1) delay, (2) delay rate of change, (3) Doppler shift, and (4) Doppler rate of change, across the entirety of cell 103 (or at least a relevant portion thereof) to create statistics masks (e.g., min, max, mean, median, etc.) across the entire overpass.

The simulation might track the position, rₛₐₜ(t), and velocity, vₛₐₜ(t), of the satellite in its trajectory. The position and velocity of the satellite will vary as a function of time in the Earth-centered, Earth-fixed (ECEF) frame of reference, but the position of cell 103 itself does not vary (in this example) and therefore its velocity is zero. So, cell 103 might be described by a set of points within cell 103 each denoted rᵢ, where i represents the “i-th” point in the set of points. To determine a one-way delay as a function of time, dᵢ(t), between the satellite and each point in the set within cell 103, the simulator might compute the one-way delay using Equation 1, where i is the i-th point within cell 103, t is a simulation point in time, and c is the speed of light.

$${d}_{i} ( t ) = ‖ {\underline{r}}_{sat} ( t ) - \underline{{r}_{i}} ‖ * \frac{1}{c} \qquad ( Eqn . 1 )$$

To determine the one-way delay rate of change for the i-th point in the set, the simulator might compute an analytical or numerical derivative of dᵢ(t) with respect to time. If a time step, Δt, is small enough, the derivative can be approximated as shown in Equation 2, where Δt is the time step.

$$\frac{d}{dt} {d}_{i} ( t ) = \frac{1}{Δ t} * [ {d}_{i} ( t + Δ t ) - {d}_{i} ( t ) ] \qquad ( Eqn . 2 )$$

To convert the one-way delay or one-way delay rate of change from units of time to units of symbols, the simulator can divide by the symbol period (unit time per symbol) for the relevant protocol or waveform(s). For example, the LTE protocol uses a symbol period of 66.7 microseconds (μs) per symbol. Generally speaking, distance, time, and symbol periods can be interchanged via the relationship shown in Equation 3, where Tₛ is a symbol period of the protocol (e.g., a constant 66.7 μs per symbol, in the case of LTE), sᵢ(t) is the number of symbol periods correspondent with the delay, dᵢ(t), as a function of time for the i-th point in the set, and the quantity in ∥ . . . ∥ is the distance that corresponds to the delay dᵢ(t) as a function of time for the i-th point in the set.

$${d}_{i} ( t ) = \frac{{T}_{s}}{{s}_{i} ( t )} = ‖ {\underline{r}}_{sat} ( t ) - \underline{{r}_{i}} ‖ * \frac{1}{c} \qquad ( Eqn . 3 )$$

In some protocols, LTE for example, the time it takes to transmit one symbol might include other elements, such as a Cyclic Prefix (CP) duration (e.g., 4.7, 5.2, or 16.7 μs) that would be added to the symbol duration referenced above, and so the symbol duration would be greater than 66.7 μs as the CP is inserted before each symbol. The duration of the CP varies depending on the position of the symbol and a base station's configuration, but the simulator can take all that into account when doing the computations. In some protocols, such as LTE, there might be a variable symbol duration that nonetheless serves as a unit reference of time that is consistent across all configurations of the protocol and can be used to serve as a base time unit. This unit of time might be used as a symbol period, in principle. However configured, the simulator could correctly compute the values based on the applicable symbol period, for various protocols and with or without the use of CPs, or other protocols elements. This can be the case even where “symbol period” might be ambiguous in the protocol. Notably, time and distance are interchangeable, as signal transmission rates can be assumed to be at, or slightly less than, c. Under specific assumptions, a symbol period would carry one-to-one relevance with a time duration, or a distance, and therefore defining a time delay with respect to a symbol period can work for various protocols, or types of protocols.

The simulator can determine the frequency offset as a function of time, Dᵢ(t), between the satellite and each point in the set within cell 103 according to Equation 4, where c is the speed of light, ƒ₀ is the originating carrier frequency of the signal, and

$${\hat{r}}_{\frac{i}{sat}} ( t )$$

is the unit vector (of length 1) describing the direction of the position of the i-th point in cell 103 with respect to the position of the satellite in the ECEF frame of reference.

$${D}_{i} ( t ) = \frac{c}{{f}_{0}} [ {\underline{v}}_{sat} ( t ) \cdot {\hat{r}}_{\frac{i}{sat}} ( t ) ] \qquad ( Eqn . 4 )$$

The simulator could use other equations instead of Equation 4 for Doppler shift. Some equations might have elements that take into account transverse velocity components for Doppler accounting. The simulator can determine the frequency offset rate of change as a function of time for the i-th point in the set and compute an analytical or numerical derivative of Dᵢ(t) with respect to time. If a time step Δt is small enough, the derivative can be approximated as shown by Equation 5, where Δt is the time step.

$$\frac{d}{dt} {D}_{i} ( t ) = \frac{1}{Δ t} * [ {D}_{i} ( t + Δ t ) - {D}_{i} ( t ) ] \qquad ( Eqn . 5 )$$

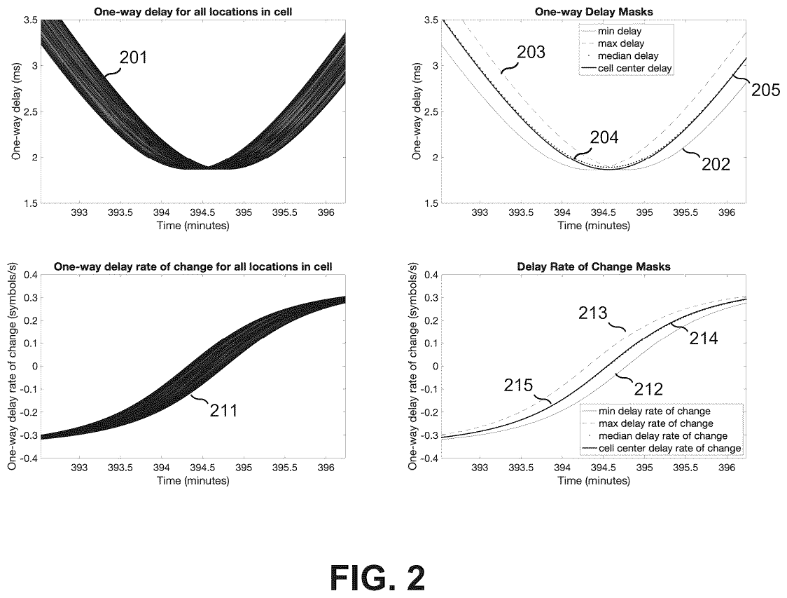

FIG. 2 illustrates the delay and delay rate of change across a cell such as cell 103 during the overpass illustrated in FIG. 1.

The plot in the upper left of FIG. 2 depicts a one-way delay (in milliseconds) for signal travel between a satellite and a UE at a location within a terrestrial cell. The one-delay could be for a signal from the satellite to the UE or for a signal from the UE to the satellite. The upper left plot depicts one-way delay for a representative sampling of locations, which could represent any or all locations within a cell, for the purposes of this example. Given that different locations within the cell have different delays, the result is a band 201 shown in the upper left plot. The time span, a little under four minutes, might correspond to an overpass of the satellite over the cell.

The plot in the upper right of FIG. 2 depicts various distillations of the data from the upper left plot, using the same scales, for one-way delay. As shown in the upper right plot, there is a minimum delay curve 202, a maximum delay curve 203, a median delay curve 204, and a cell center delay curve 205. In this particular example, median delay curve 204 and cell center delay curve 205 are nearly coincident at the extremes.

The plot in the lower left of FIG. 2 depicts a one-way delay rate of change for signal travel between the satellite and the UE, with different lines within a band 211 corresponding to different locations within the cell. With a suitable representative sampling of locations, band 211 could represent the one-way delay rate of change for all locations in the cell. In this lower left plot, the one-way delay rate of change is shown in symbols per second and uses the same time span as in the upper left plot.

The plot in the lower right of FIG. 2 depicts various distillations of the data from the lower left plot, using the same scales, for one-way delay rate of change. As shown in the lower right plot, there is a minimum delay rate of change curve 212, a maximum delay rate of change curve 213, a median delay rate of change curve 214, and a cell center delay rate of change curve 215. In this particular example, median delay rate of change curve 214 and cell center delay curve 215 are nearly coincident in places.

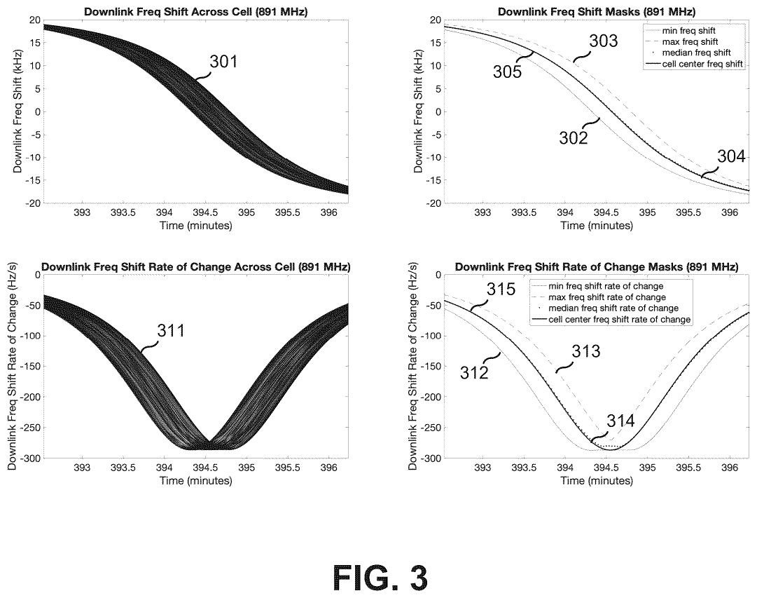

FIG. 3 illustrates a frequency offset, and frequency offset rate of change across a cell such as cell 103 during the overpass illustrated in FIG. 1.

The plot in the upper left of FIG. 3 depicts a downlink frequency shift (in kilohertz) on an 891 MHz signal between a satellite and a UE at a location within a terrestrial cell. The upper left plot depicts downlink frequency shift for a representative sampling of locations, which could represent any or all locations within a cell, for the purposes of this example. Given that different locations within the cell have different downlink frequency shifts, the result is a band 301 shown in the upper left plot. The time span, a little under four minutes, might correspond to an overpass of the satellite over the cell, as in FIG. 2.

The plot in the upper right of FIG. 3 depicts various distillations of the data from the upper left plot, using the same scales, for downlink frequency shift. As shown in the upper right plot, there is a minimum frequency shift curve 302, a maximum frequency shift curve 303, a median frequency shift curve 304, and a cell center frequency shift curve 305. In this particular example, median frequency shift curve 304 and cell center frequency shift curve 305 are nearly coincident at times.

The plot in the lower left of FIG. 3 depicts a downlink frequency shift rate of change for signal travel between the satellite and the UE, with different lines within a band 211 corresponding to different locations within the cell. With a suitable representative sampling of locations, band 211 could represent the downlink frequency shift rate of change for all locations in the cell. In this lower left plot, the downlink frequency shift rate of change is shown in hertz/second and uses the same time span as in the upper left plot.

The plot in the lower right of FIG. 3 depicts various distillations of the data from the lower left plot, using the same scales, for downlink frequency shift rate of change. As shown in the lower right plot, there is a minimum frequency shift rate of change curve 312, a maximum frequency shift rate of change curve 313, a median frequency shift rate of change curve 314, and a cell center frequency shift rate of change curve 315. In this particular example, median frequency shift rate of change curve 314 and cell center frequency shift curve 315 are nearly coincident in places.

In a typical multiple access protocol, there will be a transmit and receive frame of resource blocks in the time and/or frequency domain. In a typical terrestrial deployment of LTE in a Frequency-Division Duplex (FDD) scheme, there is an allocation of transmit resource blocks and an allocation of receive resource blocks. These resource blocks are aligned in a frame structure where there are Transmission Time Intervals (TTIs) that describe discrete time slots. In LTE, each TTI is I millisecond in duration. Normally, these would be lined up in a manner in LTE where the transmit and receive TTIs are lined up to a common reference, t_{ref}.

Although examples here describe FDD schemes, the teachings herein can be extended to Time-Division Duplex (TDD) schemes for LTE or other protocols in which transmit frames and receive frames are interleaved in time such that a base station transmits and receives at different times, but on the same set of frequencies, or resource blocks.

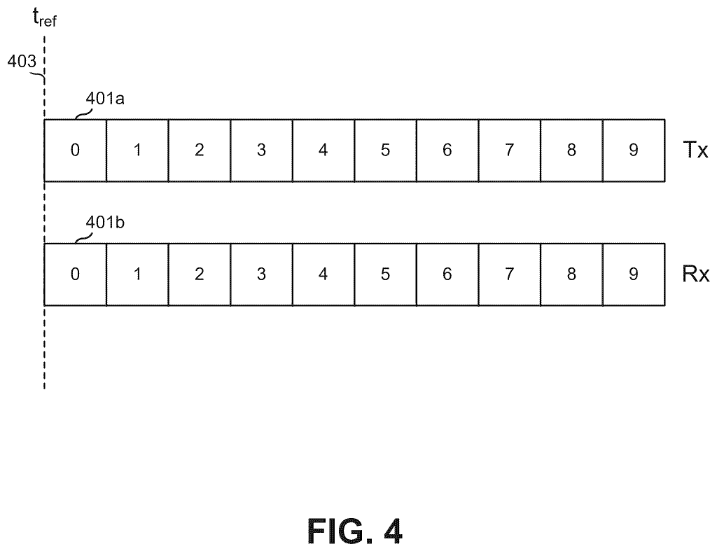

FIG. 4 illustrates how a terrestrial LTE network might be designed to align the transmit and receive frame structures. The TTI 0, or first time slot in a frame, on the transmit side, 401a, is aligned in time with TTI 0 on the receive side, 401b, to a common reference, t_{ref} 403. As a result, terrestrial LTE base stations can operate across distances between 0 km and what is allowed by the most delay-robust PRACH, which is known to those skilled in the art to be around 108 km.

Satellite orbits require distances between a UE on the Earth's surface and an eNB on a satellite that are greater than 108 km. Depending on the implementation and orbit of the satellite, a total one-way distance between the UE and the base station could be substantially larger than this, such as 200 km or 300 km for LEO, so as to avoid atmospheric drag. Furthermore, slant ranges at low elevation angles could take one-way propagation distances out to 1000 km to 2000 km for LEO. GEO satellites operate at altitudes of about 36,000 km, so even longer delays could exist.

To accommodate additional delay in the physical layer associated with orbiting space vehicle based base stations, a time slot offset could be provided, as explained in Speidel I. The time slot offset can be consistent with the minimum distance corresponding to the generic area of coverage for a particular physical layer “resource”. To extend the difference between the minimum and maximum distance of an area of coverage, an extended RACH window can be used for initial access, upon which a frequency offset and time delay can be measured/computed, and then the device assigned resources based on this measurement (along with the measurement made for the other RRC connected devices) so that the devices do not have bursts that collide in the frequency or time domain. As explained in Speidel I, this can be implemented by assigning of resources based on these measurements and “pinching” and “fraying” in the frequency domain, and “pseudo-range sorting” in the time domain.

However, if the area of coverage is a circular cell on Earth that remains fixed, the time slot offset for the cell during the overpass would compensate for the “minimum distance” line 201 shown in FIG. 2 so that any device within the range described by the minimum and maximum distance to a point on the cell can connect with the base station.

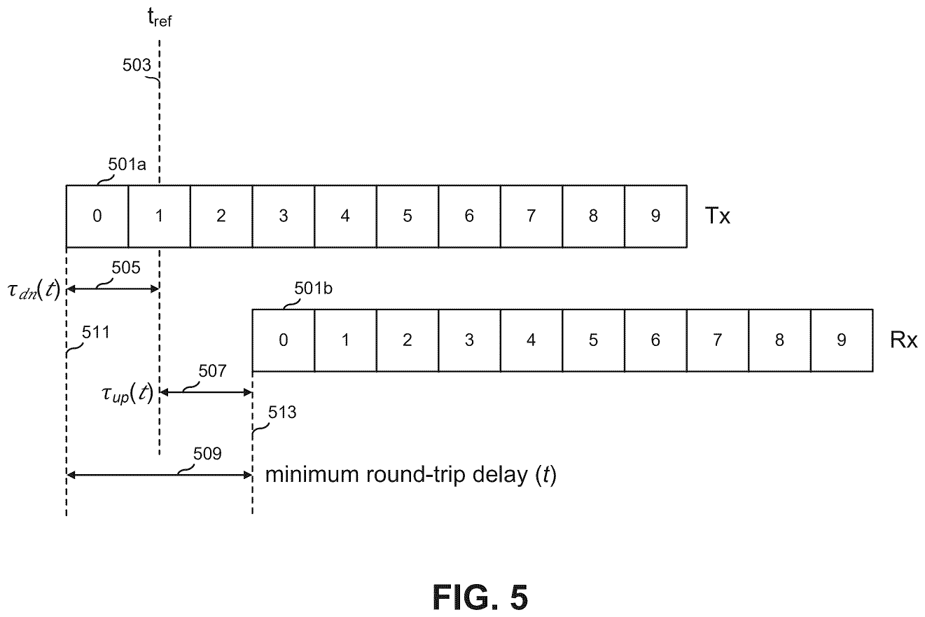

FIG. 5 illustrates an example of how this compensation technique might be used in a satellite or simulator. A Transmit (Tx) and Receive (Rx) LTE duplex subframe is illustrated. This technique could be implemented in either an FDD or TDD duplex subframe; by way of simplicity, the Tx and Rx subframes are illustrated separately but this need not indicate a requirement for separation in the frequency domain. The first TTI 501a of the Tx frame is offset from some reference, t_{ref} 503 by some offset τ_{dn}(t) 505. Similarly, the first corresponding TTI 501b on the Rx frame is offset from some reference, t_{ref} 503 by some offset τᵤₚ(t) 507. The reference t_{ref} 503 is illustrated to indicate where the first TTIs in the Tx and Rx frames, 501a and 501b, would be aligned in a typical terrestrial deployment. An alignment 511 of the Tx frame is offset from an alignment 513 of the Rx frame by the sum of the magnitude of τ_{dn}(t) 505 and τᵤₚ(t) 507, which is equivalent to the minimum round-trip delay 509 for the cell that is being served.

In this illustration, a communication condition might be the distance between the base station and the UE or a delay time that correspond to that distance, and a communication constraint might be a maximum delay allowed by the protocol in use.

FIG. 5 illustrates a compensation technique that provides for, in a particular case, using a downlink offset and an uplink offset that together sum to a round-trip offset. The round-trip offset can be equal to a minimum round-trip delay, but that might not be required. Also, the downlink offset and the uplink offset need not be equal. The compensation technique might be used in an overpass such as is shown in FIG. 1, or in other overpasses. The delays and rate of change of delays compensated for over a cell might be as shown in FIG. 2 or might have some other values.

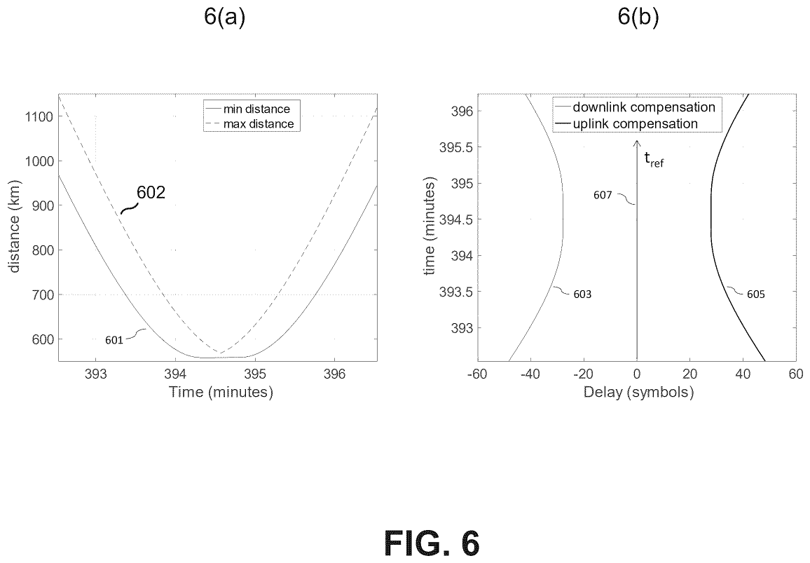

FIG. 6 illustrates some plots for distance and compensation for delay due to the distance. The data might be for an overpass such as the one illustrated in FIG. 1 and might correspond to the one-way delay plot in the upper left of FIG. 2, but the teachings of FIG. 6 might be used for other data. In the example shown there, dynamic downlink time slot offset compensation and dynamic uplink time slot offset compensation are done for each of their respective portions of the round-trip delay, which is assumed to be divided in half. In that case, the magnitude of each timeslot offset is equivalent. In other variations, the compensation is not divided equally, and in some cases, the combination of the downlink compensation and the uplink compensation might be more or less than the determined overall compensation. For example, there might be some determined overall compensation and it is allocated such that less than half of the determined overall compensation is allocated to the downlink and also less than half of the determined overall compensation is allocated to the uplink. This might be used as an option to provide coverage at a given altitude, to present a more favorable geometry in terms of delay rate of change spread over a receiver on either the downlink or the uplink, or for some other reason. The allocation of overall compensation between the downlink and the uplink might change over time, as might be the case to solving issues with the residual delay rate of change at the base station. Further, as explained herein, one compensation might be allocated differently than for another compensation. For example, round trip delay might be split, half and half, but the delay rate of change allocated differently.

FIG. 6(a) illustrates a minimum distance curve 601 (solid line) and a maximum distance curve 602 (dashed line) between a satellite and a cell. In other words, minimum distance curve 601 represents a distance from the satellite to a nearest point in the cell and maximum distance curve 602 represents a distance from the satellite to a furthest point in the cell. The minimum distance flatlines during the center of the overpass duration, which in this example corresponds to the satellite flying directly over the cell itself, as described previously. In the direct flyover, the nearest point might be moving within the cell.

In Speidel I, an approach is described wherein the compensation values of τ_{dn}(t) and τᵤₚ(t) are equivalent in magnitude to the number of symbol periods that corresponds to the distance plotted by minimum distance curve 601. In some cases described herein, those compensation values for communication conditions might be different.

FIG. 6(b) illustrates a downlink compensation curve 603 and an uplink compensation curve 605 in symbols, or symbol periods, relative to some reference t_{ref} 607, as a function of time. The number of symbol periods between downlink compensation curve 603 and uplink compensation curve 605 might be maintained equal to a minimum round-trip symbol periods on the air interface covering the cell. Downlink compensation curve 603 might be selected to be equivalent to τ_{dn}(t) shown in FIG. 5 and uplink compensation curve 605 might be selected to be equivalent to τᵤₚ(t) shown in FIG. 5.

There is an inherent challenge with this compensation approach, where τ_{dn}(t) and τᵤₚ(t) and are selected based on the minimum distance to the cell. Primarily, the minimum distance to the cell is not a single point during the overpass. The minimum distance to the cell is always the leading edge of the cell, or whatever point within the cell the satellite is directly above (if that happens to be the case). Since the compensation is catering to a moving location that is directly on the cell, there might be some geometrical constraints that make the delay rate of change hard to handle, but as described herein, this can be improved for a residual delay rate of change suitable for a typical 3GPP handset.

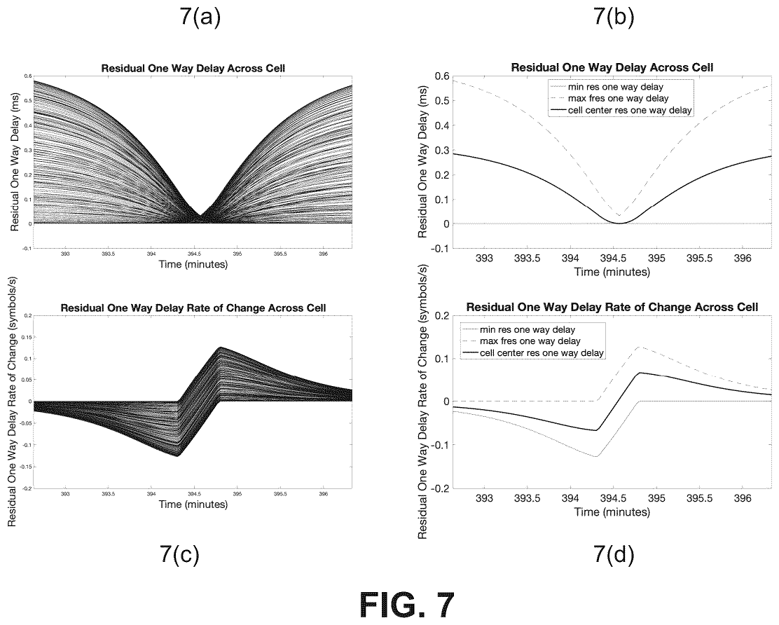

FIG. 7 illustrates effects of the compensation technique illustrated in FIG. 6. Namely, it shows what the residual one-way delay is across the cell as well as the residual one-way delay rate of change across the cell. Each of these effects is reciprocal in the uplink and downlink. FIG. 7(a) illustrates the residual one-way delay for all points in the cell. Since the delay compensation between uplink and downlink is equal to the round-trip delay, there is a portion of the cell that has zero residual delay, and the farthest side of the cell has some residual positive delay. FIG. 7(b) illustrates a mask of the min and max residual delay, coplotted with the residual delay at the cell center. FIG. 7(c) illustrates the residual one-way delay rate of change across the cell in symbols per second. There is a clear discontinuity in the curves showing the residual one-way delay rate of change across the cell, and the residual motion of the reference symbols will be sliding slowly in the time domain in one direction and then again in the opposite direction. Additionally, every location in the cell experiences some sort of residual delay, or symbol reference slip over the course of the overpass. FIG. 7(d) illustrates a mask (min and max) of the residual delay rate of change across the cell as well as the residual delay rate of change at the center of the cell.

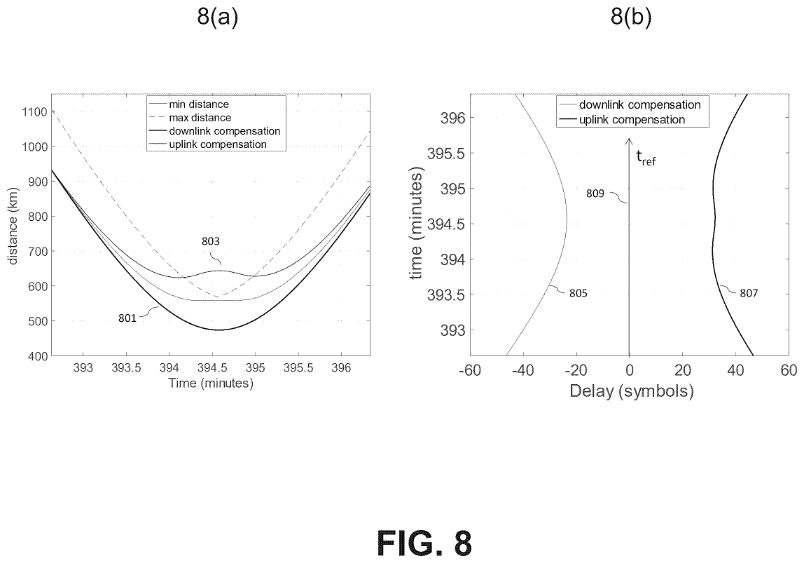

To better compensate for variable slant range across the cell, the base station can implement a different technique. The technique involves creating a time slot offset in both receive and transmit frames, but not necessarily the same offset magnitude where the transmit compensates for its portion of the round-trip delay, and the receive compensates for its portion of the round-trip delay. Instead, the downlink compensation starts at the minimum distance to the cell, and then proceeds throughout the overpass with a gradient that is the same as the change in delay as some weighted centroid of interest for the cell, which might or might not be the center of the cell, a point within the cell, or even a point that does not reside within the cell (e.g., is intentionally outside of the cell). In many embodiments, the weighted centroid could be the cell center, the geographic “delay” center, mean, or median, (e.g., the weighted centroid of delay and surface area), or the weighted “delay” center, mean, or median based on known service areas of population density (e.g., minimize delay and delay rate of change in areas within the cell that are known to be areas that the cell needs to service). In doing this, the downlink compensation actually only compensates for a portion of the downlink, one-way delay. The remainder of the two-way delay is compensated for by the uplink time slot offset. As a result, on the downlink, the gradient of the timeslot offset dynamics is smoother, resulting in reduced delay rate of change across the cell and limiting the motion of the symbol references to areas of the cell that absolutely need residual delay rate of change (like the near and far cell edges), and keeping it more consistent toward the center of the cell. This technique is illustrated in FIG. 8.

FIG. 8 illustrates dynamic downlink and uplink time slot offset compensation for the overpass illustrated in FIG. 1, where the dynamic downlink and uplink time slot offset compensation are done independently from each other, and each compensates only for less or more than their respective portion of the round-trip delay. In FIG. 8, the downlink delay compensation is set to an initial condition, with a gradient consistent with a weighted center point, or centroid, but other variations are possible. As a result, the downlink compensates only for a portion of the downlink delay, and the uplink is manipulated to compensate for the remainder of the downlink delay, plus the uplink delay. The magnitude of each time slot offset as a function of time might be the same only at the beginning of a pass and then may or may not converge to the same magnitude at the end of the pass (depending on pass duration). The sum of the downlink and uplink timeslot offset compensation remains equivalent to the round-trip delay.

FIG. 8(a) shows the min and max distance to the cell for the overpass. A downlink compensation 801 is set such that the initial condition of the curve is equal to the minimum distance to the cell at the start of the pass. For simplicity, in this example, the curve follows the same gradient as the geographic center of the cell. But as noted before, there are various embodiments that could be better, such as using the gradient of the geographic median delay. As a result, the downlink compensation reaches a minimum value that is less than the altitude of the satellite. An uplink compensation 803 is set such that it compensates for the remainder of the round-trip delay on the air interface. In effect, what this is doing is catering the downlink to a point that is still moving in inertial space but is no longer directly on the cell itself. The downlink is actually compensating initially to a point on the edge of the cell and then slowly begins compensating to a point that is above the cell in altitude, and this continues to happen until the peak of the pass when the satellite is compensating to a point in the sky above the center of the cell by approximately 85 km in this particular case. Because the compensation point is no longer on the cell itself, the effects on the downlink residual delay rate of change are substantially reduced. FIG. 8(b) illustrates the dynamic time slot offset in symbol periods for the downlink compensation, 805, and the uplink compensation, 807, relative to some reference t_{ref} 809.

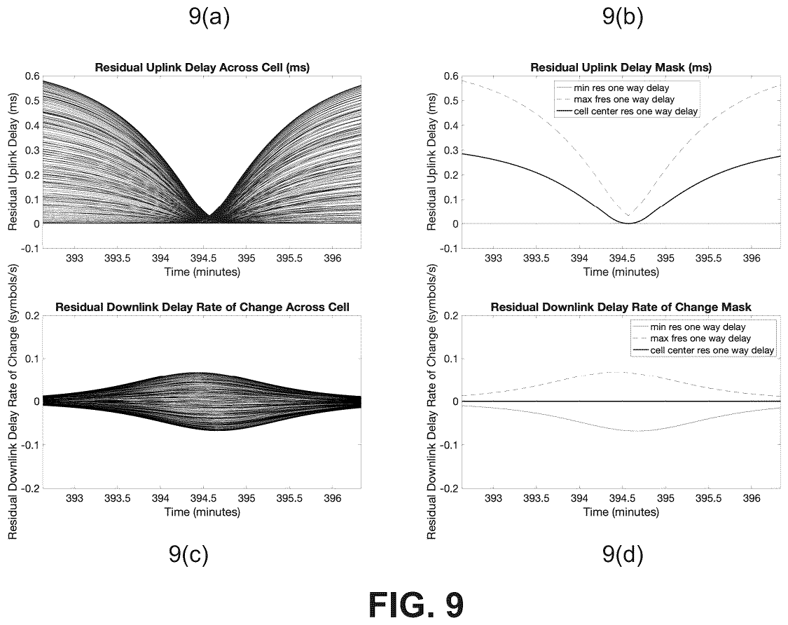

FIG. 9 illustrates the residual delay and the residual delay rate of change during the overpass based on the compensation technique illustrated in FIG. 8. FIG. 9(a) shows the residual delay across the cell. Similarly, the residual delay on the uplink across the cell always has a minimum at zero and then a maximum residual delay based on the farthest edge of the target cell. FIG. 9(b) illustrates a mask of residual delay across the cell. FIG. 9(c) illustrates the residual delay rate of change across the entire cell and FIG. 9(d) illustrates a mask (min and max) of the residual delay rate of change across the cell as well as the residual delay rate of change at the center of the cell.

When compared to FIG. 7(c), the maximum residual delay rate of change in FIG. 9(c) is approximately half the magnitude. Furthermore, there are locations within the cell (a band across the center of the cell) where the residual delay rate of change is kept to either zero, or near zero, for the entirety of the overpass. Additionally, across the cell, the residual delay rates of change do not change sign (e.g., they are always in the same direction, either positive or negative), and maintain a relatively consistent, or near constant, value for the duration of the pass. The most dynamic residual delay rates of change across the cell would then be in locations of the cell that are nearest to the nearest part of the cell, and nearest to the farthest part of the cell.

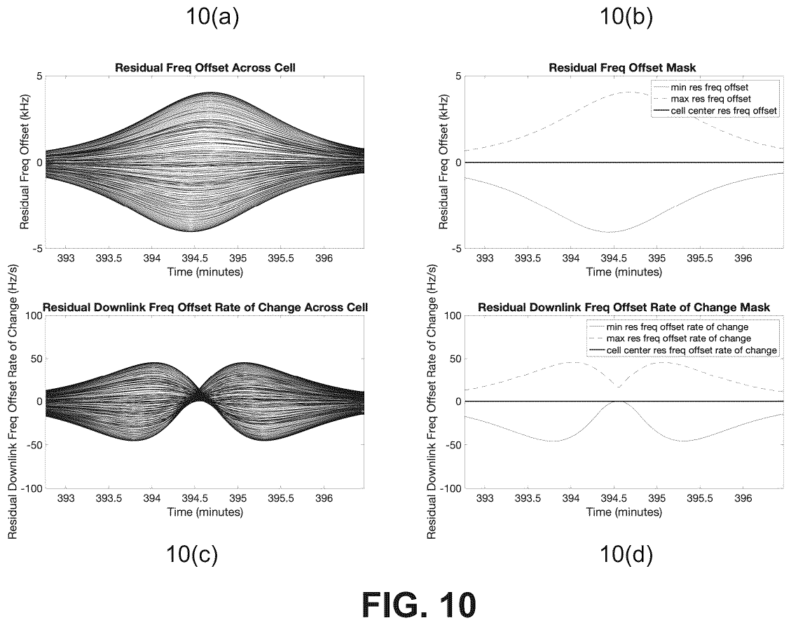

FIG. 10 illustrates compensated residual downlink frequency offset (in kHz) and compensated residual downlink frequency offset rate of change (in Hz per second) for the entirety of the cell illustrated in FIG. 1, using a downlink compensation offset that is equal to a median, or centroid, frequency offset at the start of the pass, and follows a gradient consistent with a median, or centroid, frequency offset as the pass continues. A simple form of this technique would be to compensate the downlink frequency offset for the geographic center of the desired cell of coverage, or the geographically weighted “Doppler” center of the desired cell of coverage (which is not necessarily the geometric center).

The satellite might be adapted to cater the frequency shift of its signal to best accommodate the handsets, or UEs, that are within the prescribed service cell. Specifically, the satellite might implement a frequency shift on the downlink signal that is dynamic and starts initially at the median frequency offset at the beginning of the overpass and follows some gradient that is consistent with a weighted centroid-either by surface area, or RRC connected UE distribution-similar to the compensation implemented for the dynamic timeslot offset on the downlink. On the uplink, the frequency compensation considers the expected uplink frequency shift at the median of the cell at the start of the pass, and then follows a gradient that is also consistent with some weighted centroid-either by surface area, or RRC connected UE distribution-similar to the compensation implemented for the dynamic timeslot offset on the uplink. Furthermore, on the uplink, since the base station knows the residual uplink frequency offset for each UE (and therefore the downlink frequency offset for each UE), certain channels, or transmissions, on the uplink can be further compensated for UE-by-UE transmissions, as outlined in Speidel I, for example. This can be done on the downlink, if applicable and advantageous, as well.

As explained herein, a satellite might be equipped with communications hardware that can be used in combination with instructions for signal processing, perhaps as a field-programmable gate array or a processor and software instructions executable by the processor whereby the satellite can serve as an eNB and/or as a type of orbital base station for carrying traffic to and from mobile devices on the surface of the Earth. Such mobile devices might be described as user equipment (UE), smartphones, IoT devices, or similar. Such mobile devices might be programmed and/or configured to connect to nearby cell phone towers or other terrestrial base stations and in the absence of (or in conjunction with) available nearby terrestrial base stations, the mobile device might connect with the orbital base station if the orbital base station can appear to the mobile device to be consistent with a protocol used between mobile devices and terrestrial base stations notwithstanding that the orbital base station is operating outside a design distance and/or relative velocity.

As explained herein, examples describe a mobile device as being on the surface of the Earth. It should be understood that this can apply not only to a mobile device specifically on the surface of the Earth, but a device that is a few feet above the surface of the ground, somewhat below ground (such as in a basement level of a building, a cave, a hole) where cellular signals are available, above ground in a tall building, airplane, balloon, etc. Moving relative to the ground or not, such as being on a moving train, in a car, etc., but generally not so far or moving so fast that the mobile device is not considered to be somewhere on Earth.

In an operation according to the methods and/or apparatus described herein, a cellular network connection between a terrestrial mobile device and an orbital base station is established, without requiring modifications of the terrestrial mobile device due to the orbital base station being in orbit, wherein the terrestrial mobile device and the orbital base station are configured to operate according to a protocol. The protocol might be one or more of the cellular telephone protocols in use today or in the past or in the future. Where the protocol has design assumptions of a maximum distance between communicating devices and/or a maximum relative velocity between communicating devices, the orbital base station can make adjustments and/or compensate in order to accommodate compensations or adaptations due to being outside the design assumptions and a corresponding communication constraint, such as where the terrestrial mobile device and the orbital base station are separated by more than the maximum distance and thus experiencing more delay than a communication constraint on delay, and/or are moving relative to each other in excess of the maximum relative velocity and thus experiencing more Doppler shift than a communication constraint on frequency.

In some specific operations, the orbital base station can be programmed to determine motion parameters of the orbital base station relative to a terrestrial reference point, or be provided those by another system, determine a service cell for the orbital base station to provide service to a plurality of terrestrial mobile devices that are within the service cell, or be provided with a service cell definition, and determine a service cell size of the service cell or be provided with that information. From the motion parameters, a current location of the satellite, and the terrestrial reference point, the orbital base station (or a remote system) can generate a compensations set comprising one or more communication conditions to be compensated for or adapted for by the orbital base station as a result of the being outside the design assumption as to some communication constraint. Examples of communication conditions that might be part of a compensations set, which might be stored in a structured data set readable from memory, might be one or more of (1) a delay communication condition, (2) a delay rate of change communication condition, (3) a Doppler shift communication condition, and/or (4) a rate of change of Doppler shift communication condition.

For each of the communication conditions of the compensations set, the orbital base station might compute (or be provided by a remote system) a range of values for each communication condition and/or an indication of how a value might change from the start of an overpass of the satellite over the service cell to an end of the overpass, or portions of the overpass. The orbital base station can determine (or be provided) compensations for each of the communication conditions, taking into account the ranges of values. For example, a compensation for a delay communication condition where the satellite and the terrestrial mobile device are separated by more than the maximum distance in the protocol design assumptions might be a compensation that results in the terrestrial mobile device sensing a delay that is within the protocol design assumptions, perhaps by sending a signal from the orbital base station earlier than is specified by the protocol.

A compensation for a particular communication condition might be split into a downlink compensation portion and an uplink compensation portion that together correspond to the compensation, whereby the downlink compensation portion is applied to a downlink signal that is to be sent to the terrestrial mobile device in the service cell from the orbital base station and, upon receipt of an uplink signal from the terrestrial mobile device, the orbital base station applies the uplink compensation portion to the uplink signal. In some cases, the downlink compensation portion and the uplink compensation portion are the same and in other cases, they differ. Thus, the ratio of the downlink compensation portion and the uplink compensation portion might be 1.0 or more than 1.0 or less than 1.0. Further, the ratio might change throughout an overpass of the service cell.

In a method or apparatus described herein, a cellular network connection might be established between a terrestrial mobile device and an orbital base station housed on a satellite, in orbit or to be placed in orbit, wherein the terrestrial mobile device and the orbital base station are configured to operate according to a protocol, wherein the protocol has some design assumptions of communication conditions and imposes communication constraints. To provide for compensation for such communication conditions and imposed communication constraints, the orbital base station can use a compensations set to adapt communications with a UE and the adaptation could result in the UE connecting a link with the orbital base station as if the UE were communicating with a terrestrial base station. With this approach, satellite-specific modifications to a UE are not required.

Such a method might involve determining motion parameters of an orbital base station relative to a terrestrial reference point where a UE might be located, determining a service cell for the satellite to provide service to a plurality of terrestrial mobile devices that are within the service cell, wherein the plurality of terrestrial mobile devices includes the terrestrial mobile device, determining a service cell size of the service cell, and determining, based on the motion parameters, a current location of the satellite, and the terrestrial reference point, a compensations set comprising one or more communication conditions to be compensated for by the orbital base station as a result of being outside the design assumptions. The orbital base station might then determine, for at least one communication condition of the compensations set, a range of values for the at least one communication condition throughout an overpass of the satellite over the service cell, determine a compensation for the at least one communication condition, taking into account the range of values, and then determine a downlink compensation portion and an uplink compensation portion that together correspond to the compensation. The downlink compensation portion can be applied to a downlink signal that is to be sent to the terrestrial mobile device in the service cell and, upon receipt of an uplink signal from the terrestrial mobile device, the uplink compensation portion can be applied to the uplink signal.

For the delay communication condition, the orbital base station might use a range of delays throughout the overpass where the downlink compensation portion provides a target set of apparent delays to the plurality of terrestrial mobile devices in the service cell, and the uplink compensation portion adapts the uplink signal so that the downlink compensation portion and the uplink compensation portion together adapt for round-trip delays in communications between the satellite and a given terrestrial mobile device. To accommodate multiple terrestrial mobile devices that might be in different places in the service cell, the orbital base station might select the downlink compensation portion and the uplink compensation portion to accommodate multiple devices, perhaps adjusting to account for the case where more devices are expected in some portion of the service cell than others.

For the delay rate of change communication condition, the orbital base station might use a range of delay rates of change throughout the overpass where the downlink compensation portion provides a target set of apparent delay rates of change to the plurality of terrestrial mobile devices, and the uplink compensation portion adapts the uplink signal so that the downlink compensation portion and the uplink compensation portion together adapt for rates of change of round-trip delays in communications between the satellite and a given terrestrial mobile device.

For the Doppler shift communication condition, the orbital base station might use a range of Doppler shifts throughout the overpass where the downlink compensation portion provides a target set of apparent Doppler shifts to the plurality of terrestrial mobile devices, and the uplink compensation portion adapts the uplink signal such that the downlink compensation portion and the uplink compensation portion together adapt for round-trip Doppler shifts in communications between the satellite and the terrestrial mobile device notwithstanding moving relative by more than the maximum relative velocity.

For the rate of change of Doppler shift communication condition, the orbital base station might use a range of rates of change of Doppler shift throughout the overpass where the downlink compensation portion provides a target set of apparent rates of change of Doppler shift to the plurality of terrestrial mobile devices, and the uplink compensation portion adapts the uplink signal so that the downlink compensation portion and the uplink compensation portion together adapt for round-trip rates of change of Doppler shifts in communications between the satellite and the terrestrial mobile device notwithstanding moving relative by more than the maximum relative velocity.

The downlink compensation portion and the uplink compensation portion might be selected to reduce or minimize variation of the at least one communication condition as seen by the terrestrial mobile device. Reducing or minimizing variation of the at least one communication condition as seen by the terrestrial mobile device might comprise reducing a rate of change of the variation. Reducing or minimizing variation of the at least one communication condition as seen by the terrestrial mobile device might comprise reducing a rate of change of a rate of change of the variation.

The orbital base station might select (or might be provided) a downlink compensation portion and an uplink compensation portion based on the minimum distance to the service cell. The downlink compensation portion and the uplink compensation portion might have different magnitudes. The downlink compensation portion might be zero at a minimum distance to the service cell and change with a gradient equal to a change in delay as a weighted centroid of interest for the service cell. The weighted centroid might be the cell center, a geographic delay center, a mean, or a weighted centroid of delay and surface area. The weighted centroid might be based on population density across the service cell. How a base station is programmed or configured might be a function of a shape of a desired cell and its location relative to satellite position and velocity vector at some point in time. These details can be computed in software, possibly computing a preferred approach on the fly for a given input cell position, cell shape, and satellite trajectory. The orbital base station might compute this on an overpass-by-overpass basis, or it can be computed remotely and provided to the orbital base station.

The downlink compensation portion and uplink compensation portions might comprise one or more of a frequency shift catered to a cell median Doppler contour, a first compensation for delay and delay rate of change on a downlink signal according to a weighted centroid delay rate of change contour, and/or a second compensation for delay and delay rate of change on an uplink signal according to a remaining round-trip delay not accounted for by the first dynamic compensation for delay and delay rate of change used on the downlink signal.

The downlink compensation portion might be adjusted based on motion of the satellite relative to a point in space that is moving relative to the service cell and is at an altitude above the service cell and/or the downlink compensation portion might be adjusted based on motion of the satellite initially on an edge of the service cell and transition to a point in space that is at an altitude above the service cell a peak of a pass when the point is above a center of the service cell.

A non-transitory computer-readable storage medium storing instructions might be provided that, when executed by at least one processor of a computer system, causes the computer system to carry out a method described herein. This might be done by a computer system comprising one or more processors and a storage medium storing instructions, which when executed by the at least one processor, cause the system to implement the methods.

Operations described herein that might be described as being performed by an orbital base station might be performed remotely and the results provided to the orbital base station. Where some operations cannot be performed remotely, and the results communicated to the orbital base station in a timely matter, those operations might be performed at the orbital base station.

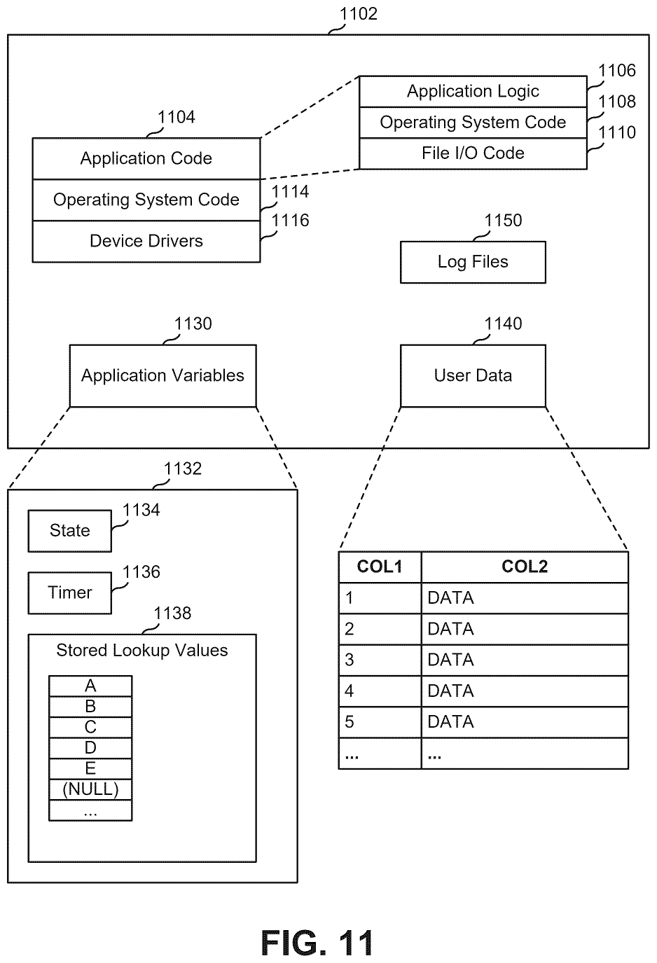

FIG. 11 is a simplified functional block diagram of a storage device 1102 having an application that can be accessed and executed by a processor in a computer system as might be part of embodiments of a satellite and/or an eNB implemented on a satellite in Earth orbit and/or a computer system that compensates for one or more of delay, rate of change of delay, Doppler shift, and/or rate of change of Doppler shift. FIG. 11 also illustrates an example of memory elements that might be used by a processor to implement elements of the embodiments described herein. In some embodiments, the data structures are used by various components and tools, some of which are described in more detail herein. The data structures and program code used to operate on the data structures may be provided and/or carried by a transitory computer readable medium, e.g., a transmission medium such as in the form of a signal transmitted over a network. For example, where a functional block is referenced, it might be implemented as program code stored in memory. The application can be one or more of the applications described herein, running on servers, clients or other platforms or devices and might represent memory of one of the clients and/or servers illustrated elsewhere.

Storage device 1102 can be one or more memory device that can be accessed by a processor and storage device 1102 can have stored thereon application code 1104 that can be one or more processor readable instructions, in the form of write-only memory and/or writable memory. Application code 1104 can include application logic 1106, library functions 1108, and file I/O functions code 1110 associated with the application. The memory elements of FIG. 11 might be used for a server or computer that interfaces with a user, generates data, and/or manages other aspects of a process described herein. In addition to application code 1104, storage device 1102 might also contain operating system code 1114 and device drivers 1116.

Storage device 1102 can also include storage for application variables 1130 that can include one or more storage locations configured to receive variables 1132. Application variables 1130 can include variables that are generated by the application or otherwise local to the application, such as state variables 1134, timers 1136, and/or stored lookup values 1138. Application variables 1130 can be generated, for example, from data retrieved from an external source, such as a user or an external device or application. A processor can execute application code 1104 to generate application variables 1130 provided to storage device 1102. Application variables 1130 might include operational details needed to perform the functions described herein.

Storage device 1102 can include storage for databases and other data described herein. One or more memory locations can be configured to store user data 1140, which might include data sourced by an external source, such as a user or an external device. User data 1140 can include, for example, records being passed between servers prior to being transmitted or after being received. Other data might also be supplied.

Storage device 1102 can also include log files 1150 having one or more storage locations configured to store results of the application or inputs provided to the application. For example, log files 1150 can be configured to store a history of actions, alerts, error messages, and the like.

According to some embodiments, the techniques described herein are implemented by one or more generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

One embodiment might include a carrier medium carrying data that includes data having been processed by the methods described herein. The carrier medium can comprise any medium suitable for carrying the data, including a storage medium, e.g., solid-state memory, an optical disk or a magnetic disk, or a transient medium, e.g., a signal carrying the data such as a signal transmitted over a network, a digital signal, a radio frequency signal, an acoustic signal, an optical signal or an electrical signal.

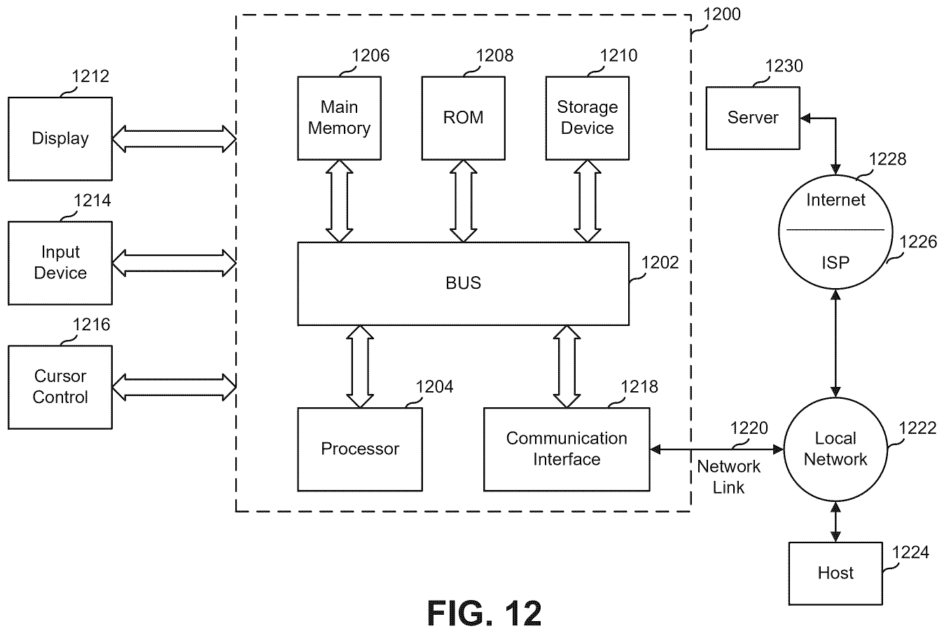

FIG. 12 is a block diagram that illustrates a computer system 1200 upon which the computer systems of the systems described herein and/or data structures shown in FIG. 11 may be implemented. Computer system 1200 includes a bus 1202 or other communication mechanism for communicating information, and a processor 1204 coupled with bus 1202 for processing information. Processor 1204 might be, for example, a general-purpose microprocessor.

Computer system 1200 also includes a main memory 1206, such as a random-access memory (RAM) or other dynamic storage device, coupled to bus 1202 for storing information and instructions to be executed by processor 1204. Main memory 1206 might also be used for storing temporary variables or other intermediate information during execution of instructions to be executed by processor 1204. Such instructions, when stored in non-transitory storage media accessible to processor 1204, render computer system 1200 into a special-purpose machine that is customized to perform the operations specified in the instructions.

Computer system 1200 further includes a read only memory (ROM) 1208 or other static storage device coupled to bus 1202 for storing static information and instructions for processor 1204. A storage device 1210, such as a magnetic disk or optical disk, is provided and coupled to bus 1202 for storing information and instructions.

Computer system 1200 might be coupled via bus 1202 to a display 1212, such as a computer monitor, for displaying information to a computer user. An input device 1214, including alphanumeric and other keys, is coupled to bus 1202 for communicating information and command selections to processor 1204. Another type of user input device is a cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

Computer system 1200 might implement the techniques described herein using customized hard-wired logic, one or more ASICs or FPGAs, firmware and/or program logic which in combination with the computer system causes or programs computer system 1200 to be a special-purpose machine. According to one embodiment, the techniques herein are performed by computer system 1200 in response to processor 1204 executing one or more sequences of one or more instructions contained in main memory 1206. Such instructions might be read into main memory 1206 from another storage medium, such as storage device 1210. Execution of the sequences of instructions contained in main memory 1206 causes processor 1204 to perform the process steps described herein. In alternative embodiments, hard-wired circuitry might be used in place of or in combination with software instructions.

The term “storage media” as used herein refers to any non-transitory media that store data and/or instructions that cause a machine to operation in a specific fashion. Such storage media might include non-volatile media and/or volatile media. Non-volatile media includes, for example, optical or magnetic disks, such as storage device 1210. Volatile media includes dynamic memory, such as main memory 1206. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but might be used in conjunction with transmission media. Transmission media participates in transferring information between storage media. For example, transmission media includes coaxial cables, copper wire, and fiber optics, including the wires that include bus 1202. Transmission media can also take the form of acoustic or light waves, such as those generated during radio-wave and infra-red data communications.

Various forms of media might be involved in carrying one or more sequences of one or more instructions to processor 1204 for execution. For example, the instructions might initially be carried on a magnetic disk or solid-state drive of a remote computer. The remote computer can load the instructions into its dynamic memory and send the instructions over a network connection. A modem or network interface local to computer system 1200 can receive the data. Bus 1202 carries the data to main memory 1206, from which processor 1204 retrieves and executes the instructions. The instructions received by main memory 1206 might optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 might be a network card, a modem, a cable modem, or a satellite modem to provide a data communication connection to a corresponding type of telephone line or communications line. Wireless links might also be implemented. In any such implementation, communication interface 1218 sends and receives electrical, electromagnetic, or optical signals that carry digital data streams representing various types of information.

Network link 1220 typically provides data communication through one or more networks to other data devices. For example, network link 1220 might provide a connection through local network 1222 to a host computer 1224 or to data equipment operated by an Internet Service Provider (ISP) 1226. ISP 1226 in turn provides data communication services through the world-wide packet data communication network now commonly referred to as the “Internet” 1228. Local network 1222 and Internet 1228 both use electrical, electromagnetic, or optical signals that carry digital data streams. The signals through the various networks and the signals on network link 1220 and through communication interface 1218, which carry the digital data to and from computer system 1200, are example forms of transmission media.

Computer system 1200 can send messages and receive data, including program code, through the network(s), network link 1220, and communication interface 1218. In the Internet example, a server 1230 might transmit a requested code for an application program through the Internet 1228, ISP 1226, local network 1222, and communication interface 1218. The received code might be executed by processor 1204 as it is received, and/or stored in storage device 1210, or other non-volatile storage for later execution.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code might be stored on a computer-readable storage medium, for example, in the form of a computer program comprising a plurality of instructions executable by one or more processors. The computer-readable storage medium might be non-transitory. The code might also be provided carried by a transitory computer readable medium e.g., a transmission medium such as in the form of a signal transmitted over a network.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Various combinations of the elements described herein might be implemented after reading the disclosure and accompanying figures, including those described by the following clauses and implementations of intermediate specificity:

Clause 1. A method of communication over a cellular network connection between a terrestrial mobile device and an orbital base station housed by a satellite, wherein the terrestrial mobile device and the orbital base station are configured to operate according to a protocol, wherein the protocol has a design assumption of a maximum distance between communicating devices and/or a maximum relative velocity between communicating devices, and wherein the terrestrial mobile device and the orbital base station are separated by more than the maximum distance and/or are moving relative to each other in excess of the maximum relative velocity and the orbital base station is to compensate for being outside the design assumption, the method comprising:
determining motion parameters of the orbital base station relative to a terrestrial reference point;
determining a service cell for the orbital base station to provide service to a plurality of terrestrial mobile devices that are within the service cell, wherein the plurality of terrestrial mobile devices includes the terrestrial mobile device;
determining a service cell size of the service cell;
determining, based on the motion parameters, a current location of the satellite, and the terrestrial reference point, a compensations set comprising one or more communication conditions to be compensated for by the orbital base station as a result of being outside the design assumption;
determining, for at least one communication condition of the compensations set, a range of values for the at least one communication condition throughout an overpass of the satellite over the service cell;
determining a compensation for the at least one communication condition, taking into account the range of values:
determining a downlink compensation portion and an uplink compensation portion that together correspond to the compensation;
applying the downlink compensation portion to a downlink signal that is to be sent to the terrestrial mobile device in the service cell; and
upon receipt of an uplink signal from the terrestrial mobile device, applying the uplink compensation portion to the uplink signal.

Clause 2. The method of clause 1, wherein the design assumption is an assumption of the maximum distance between communicating devices, wherein the orbital base station is configured to be separated from the terrestrial mobile device by more than the maximum distance, wherein the compensations set comprises a delay communication condition to be adapted for by the orbital base station, wherein the range of values is a range of delays throughout the overpass, wherein the downlink compensation portion provides a target set of apparent delays to the plurality of terrestrial mobile devices, wherein the uplink compensation portion adapts the uplink signal, and wherein the downlink compensation portion and the uplink compensation portion together adapt for round-trip delays in communications between the orbital base station and the terrestrial mobile device notwithstanding being separated by more than the maximum distance.

Clause 3. The method of clause 1 and/or 2, wherein the design assumption is an assumption of the maximum distance between communicating devices, wherein the compensations set comprises a delay rate of change communication condition to be adapted for by the orbital base station, wherein the range of values is a range of delay rates of change throughout the overpass, wherein the downlink compensation portion provides a target set of apparent delay rates of change to the plurality of terrestrial mobile devices, wherein the uplink compensation portion adapts the uplink signal, and wherein the downlink compensation portion and the uplink compensation portion together adapt for rates of change of round-trip delays in communications between the orbital base station and the terrestrial mobile device notwithstanding being separated by more than the maximum distance.

Clause 4. The method of one or more of clauses 1 to 3, wherein the design assumption is an assumption of the maximum relative velocity between communicating devices, wherein the orbital base station is configured to operate while moving relative to the terrestrial mobile device by more than the relative velocity, wherein the compensations set comprises a Doppler shift communication condition to be adapted for by the orbital base station, wherein the range of values is a range of Doppler shifts throughout the overpass, wherein the downlink compensation portion provides a target set of apparent Doppler shifts to the plurality of terrestrial mobile devices, wherein the uplink compensation portion adapts the uplink signal, and wherein the downlink compensation portion and the uplink compensation portion together adapt for round-trip Doppler shifts in communications between the orbital base station and the terrestrial mobile device notwithstanding moving relative by more than the maximum relative velocity.

Clause 5. The method of one or more of clauses 1 to 4, wherein the design assumption is an assumption of the maximum relative velocity between communicating devices, wherein the compensations set comprises a rate of change of Doppler shift communication condition to be adapted for by the orbital base station, wherein the range of values is a range of rates of change of Doppler shift throughout the overpass, wherein the downlink compensation portion provides a target set of apparent rates of change of Doppler shift to the plurality of terrestrial mobile devices, wherein the uplink compensation portion adapts the uplink signal, and wherein the downlink compensation portion and the uplink compensation portion together adapt for round-trip rates of change of Doppler shifts in communications between the orbital base station and the terrestrial mobile device notwithstanding moving relative by more than the maximum relative velocity.

Clause 6. The method of one or more of clauses 1 to 5, wherein the downlink compensation portion and the uplink compensation portion are selected to reduce or minimize variation of the at least one communication condition as seen by the terrestrial mobile device.

Clause 7. The method of clause 6, wherein reducing or minimizing the variation of the at least one communication condition as seen by the terrestrial mobile device comprises reducing a rate of change of the variation.

Clause 8. The method of clause 6 and/or 7, wherein reducing or minimizing the variation of the at least one communication condition as seen by the terrestrial mobile device comprises reducing a rate of change of a rate of change of the variation.

Clause 9. The method of one or more of clauses 1 to 8, wherein the downlink compensation portion and the uplink compensation portion are selected based on a minimum distance to the service cell.

Clause 10. The method of one or more of clauses 1 to 9, wherein the downlink compensation portion and the uplink compensation portion have different magnitudes.

Clause 11. The method of one or more of clauses 1 to 20, wherein the downlink compensation portion is zero at a minimum distance to the service cell, and changes with a gradient equal to a change in delay as a weighted centroid of interest for the service cell.

Clause 12. The method of clause 11, wherein the weighted centroid is a service cell center, a geographic delay center, a mean, or a weighted centroid of delay and surface area.

Clause 13. The method of clause 11 and/or clause 12, wherein the weighted centroid is based on population density across the service cell.

Clause 14. The method of one or more of clauses 1 to 13, wherein the downlink compensation portion and the uplink compensation portion each comprise one or more of a frequency shift catered to a cell median Doppler contour, a first compensation for delay and delay rate of change on a downlink signal according to a weighted centroid delay rate of change contour, and/or a second compensation for delay and delay rate of change on an uplink signal according to a remaining round-trip delay not accounted for by the first compensation for delay and delay rate of change used on the downlink signal.

Clause 15. The method of one or more of clauses 1 to 14, further comprising adjusting the downlink compensation portion based on motion of the satellite relative to a point in space that is moving relative to the service cell and is at an altitude above the service cell.

Clause 16. The method of one or more of clauses 1 to 15, further comprising adjusting the downlink compensation portion based on motion of the satellite initially on an edge of the service cell and transitions to a point in space that is at an altitude above the service cell a peak of a pass when the point is above a center of the service cell.

Clause 17. A non-transitory computer-readable storage medium storing instructions, which when executed by at least one processor of a computer system, causes the computer system to:
initiate communication for a cellular network connection between a terrestrial mobile device and an orbital base station housed by a satellite, wherein the terrestrial mobile device and the orbital base station are configured to operate according to a protocol, wherein the protocol has a design assumption of a maximum distance between communicating devices and/or a maximum relative velocity between communicating devices, and wherein the terrestrial mobile device and the orbital base station are separated by more than the maximum distance and/or are moving relative to each other in excess of the maximum relative velocity and the orbital base station is to compensate for being outside the design assumption;
determine motion parameters of the orbital base station relative to a terrestrial reference point;
determine a service cell for the orbital base station to provide service to a plurality of terrestrial mobile devices that are within the service cell, wherein the plurality of terrestrial mobile devices includes the terrestrial mobile device;
determine a service cell size of the service cell;
determine, based on the motion parameters, a current location of the satellite, and the terrestrial reference point, a compensations set comprising one or more communication conditions to be adapted for by the orbital base station as a result of the being outside the design assumption;
determine, for at least one communication condition of the compensations set, a range of values for the at least one communication condition throughout an overpass of the satellite over the service cell;
determine a compensation for the at least one communication condition, taking into account the range of values:
determine a downlink compensation portion and an uplink compensation portion that together correspond to the compensation;
apply the downlink compensation portion to a downlink signal that is to be sent to the terrestrial mobile device in the service cell; and
upon receipt of an uplink signal from the terrestrial mobile device, apply the uplink compensation portion to the uplink signal.

Clause 18. The non-transitory computer-readable storage medium of clause 17, wherein the design assumption is an assumption of the maximum relative velocity between communicating devices, wherein the compensations set comprises a rate of change of Doppler shift communication condition to be adapted for by the orbital base station, wherein the range of values is a range of rates of change of Doppler shift throughout the overpass, wherein the downlink compensation portion provides a target set of apparent rates of change of Doppler shift to the plurality of terrestrial mobile devices, wherein the uplink compensation portion adapts the uplink signal, and wherein the downlink compensation portion and the uplink compensation portion together adapt for round-trip rates of change of Doppler shifts in communications between the orbital base station and the terrestrial mobile device notwithstanding moving relative by more than the maximum relative velocity.

Clause 19. The non-transitory computer-readable storage medium of clause 17 and/or clause 18, wherein the downlink compensation portion and the uplink compensation portion are selected to reduce or minimize variation of the at least one communication condition as seen by the terrestrial mobile device, and wherein reducing or minimizing the variation of the at least one communication condition as seen by the terrestrial mobile device comprises (1) reducing a rate of change of the variation, and/or (2) reducing a rate of change of a rate of change of the variation.

Clause 20. The non-transitory computer-readable storage medium of any one of clauses 17 to 19, wherein the downlink compensation portion and the uplink compensation portion have different magnitudes.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A method of communication over a cellular network connection between a terrestrial mobile device and an orbital base station housed by a satellite, wherein the terrestrial mobile device and the orbital base station are configured to operate according to a protocol, wherein the protocol has a design assumption of a maximum distance between communicating devices and/or a maximum relative velocity between communicating devices, and wherein the terrestrial mobile device and the orbital base station are separated by more than the maximum distance and/or are moving relative to each other in excess of the maximum relative velocity and the orbital base station is to compensate for being outside the design assumption, the method comprising:
determining motion parameters of the orbital base station relative to a terrestrial reference point;
determining a service cell for the orbital base station to provide service to a plurality of terrestrial mobile devices that are within the service cell, wherein the plurality of terrestrial mobile devices includes the terrestrial mobile device;
determining a service cell size of the service cell;
determining, based on the motion parameters, a current location of the satellite, and the terrestrial reference point, a compensations set comprising one or more communication conditions to be compensated for by the orbital base station as a result of being outside the design assumption;
determining, for at least one communication condition of the compensations set, a range of values for the at least one communication condition throughout an overpass of the satellite over the service cell;
determining a compensation for the at least one communication condition, taking into account the range of values:
determining a downlink compensation portion and an uplink compensation portion that together correspond to the compensation;
applying the downlink compensation portion to a downlink signal that is to be sent to the terrestrial mobile device in the service cell; and
upon receipt of an uplink signal from the terrestrial mobile device, applying the uplink compensation portion to the uplink signal.

2. The method of claim 1, wherein the design assumption is an assumption of the maximum distance between communicating devices, wherein the orbital base station is configured to be separated from the terrestrial mobile device by more than the maximum distance, wherein the compensations set comprises a delay communication condition to be adapted for by the orbital base station, wherein the range of values is a range of delays throughout the overpass, wherein the downlink compensation portion provides a target set of apparent delays to the plurality of terrestrial mobile devices, wherein the uplink compensation portion adapts the uplink signal, and wherein the downlink compensation portion and the uplink compensation portion together adapt for round-trip delays in communications between the orbital base station and the terrestrial mobile device notwithstanding being separated by more than the maximum distance.

3. The method of claim 1, wherein the design assumption is an assumption of the maximum distance between communicating devices, wherein the compensations set comprises a delay rate of change communication condition to be adapted for by the orbital base station, wherein the range of values is a range of delay rates of change throughout the overpass, wherein the downlink compensation portion provides a target set of apparent delay rates of change to the plurality of terrestrial mobile devices, wherein the uplink compensation portion adapts the uplink signal, and wherein the downlink compensation portion and the uplink compensation portion together adapt for rates of change of round-trip delays in communications between the orbital base station and the terrestrial mobile device notwithstanding being separated by more than the maximum distance.

4. The method of claim 1, wherein the design assumption is an assumption of the maximum relative velocity between communicating devices, wherein the orbital base station is configured to operate while moving relative to the terrestrial mobile device by more than the relative velocity, wherein the compensations set comprises a Doppler shift communication condition to be adapted for by the orbital base station, wherein the range of values is a range of Doppler shifts throughout the overpass, wherein the downlink compensation portion provides a target set of apparent Doppler shifts to the plurality of terrestrial mobile devices, wherein the uplink compensation portion adapts the uplink signal, and wherein the downlink compensation portion and the uplink compensation portion together adapt for round-trip Doppler shifts in communications between the orbital base station and the terrestrial mobile device notwithstanding moving relative by more than the maximum relative velocity.

5. The method of claim 1, wherein the design assumption is an assumption of the maximum relative velocity between communicating devices, wherein the compensations set comprises a rate of change of Doppler shift communication condition to be adapted for by the orbital base station, wherein the range of values is a range of rates of change of Doppler shift throughout the overpass, wherein the downlink compensation portion provides a target set of apparent rates of change of Doppler shift to the plurality of terrestrial mobile devices, wherein the uplink compensation portion adapts the uplink signal, and wherein the downlink compensation portion and the uplink compensation portion together adapt for round-trip rates of change of Doppler shifts in communications between the orbital base station and the terrestrial mobile device notwithstanding moving relative by more than the maximum relative velocity.

6. The method of claim 1, wherein the downlink compensation portion and the uplink compensation portion are selected to reduce or minimize variation of the at least one communication condition as seen by the terrestrial mobile device.

7. The method of claim 6, wherein reducing or minimizing the variation of the at least one communication condition as seen by the terrestrial mobile device comprises reducing a rate of change of the variation.

8. The method of claim 6, wherein reducing or minimizing the variation of the at least one communication condition as seen by the terrestrial mobile device comprises reducing a rate of change of a rate of change of the variation.

9. The method of claim 1, wherein the downlink compensation portion and the uplink compensation portion are selected based on a minimum distance to the service cell.

10. The method of claim 1, wherein the downlink compensation portion and the uplink compensation portion have different magnitudes.

11. The method of claim 1, wherein the downlink compensation portion is zero at a minimum distance to the service cell, and changes with a gradient equal to a change in delay as a weighted centroid of interest for the service cell.

12. The method of claim 11, wherein the weighted centroid is a service cell center, a geographic delay center, a mean, or a weighted centroid of delay and surface area.

13. The method of claim 11, wherein the weighted centroid is based on population density across the service cell.

14. The method of claim 1, wherein the downlink compensation portion and the uplink compensation portion each comprise one or more of a frequency shift catered to a cell median Doppler contour, a first compensation for delay and delay rate of change on a downlink signal according to a weighted centroid delay rate of change contour, and/or a second compensation for delay and delay rate of change on an uplink signal according to a remaining round-trip delay not accounted for by the first compensation for delay and delay rate of change used on the downlink signal.

15. The method of claim 1, further comprising adjusting the downlink compensation portion based on motion of the satellite relative to a point in space that is moving relative to the service cell and is at an altitude above the service cell.

16. The method of claim 1, further comprising adjusting the downlink compensation portion based on motion of the satellite initially on an edge of the service cell and transitions to a point in space that is at an altitude above the service cell a peak of a pass when the point is above a center of the service cell.

17. A non-transitory computer-readable storage medium storing instructions, which when executed by at least one processor of a computer system, causes the computer system to:
initiate communication for a cellular network connection between a terrestrial mobile device and an orbital base station housed by a satellite, wherein the terrestrial mobile device and the orbital base station are configured to operate according to a protocol, wherein the protocol has a design assumption of a maximum distance between communicating devices and/or a maximum relative velocity between communicating devices, and wherein the terrestrial mobile device and the orbital base station are separated by more than the maximum distance and/or are moving relative to each other in excess of the maximum relative velocity and the orbital base station is to compensate for being outside the design assumption;
determine motion parameters of the orbital base station relative to a terrestrial reference point;
determine a service cell for the orbital base station to provide service to a plurality of terrestrial mobile devices that are within the service cell, wherein the plurality of terrestrial mobile devices includes the terrestrial mobile device;
determine a service cell size of the service cell;
determine, based on the motion parameters, a current location of the satellite, and the terrestrial reference point, a compensations set comprising one or more communication conditions to be adapted for by the orbital base station as a result of the being outside the design assumption;
determine, for at least one communication condition of the compensations set, a range of values for the at least one communication condition throughout an overpass of the satellite over the service cell;
determine a compensation for the at least one communication condition, taking into account the range of values:
determine a downlink compensation portion and an uplink compensation portion that together correspond to the compensation;
apply the downlink compensation portion to a downlink signal that is to be sent to the terrestrial mobile device in the service cell; and
upon receipt of an uplink signal from the terrestrial mobile device, apply the uplink compensation portion to the uplink signal.

18. The non-transitory computer-readable storage medium of claim 17, wherein the design assumption is an assumption of the maximum relative velocity between communicating devices, wherein the compensations set comprises a rate of change of Doppler shift communication condition to be adapted for by the orbital base station, wherein the range of values is a range of rates of change of Doppler shift throughout the overpass, wherein the downlink compensation portion provides a target set of apparent rates of change of Doppler shift to the plurality of terrestrial mobile devices, wherein the uplink compensation portion adapts the uplink signal, and wherein the downlink compensation portion and the uplink compensation portion together adapt for round-trip rates of change of Doppler shifts in communications between the orbital base station and the terrestrial mobile device notwithstanding moving relative by more than the maximum relative velocity.

19. The non-transitory computer-readable storage medium of claim 17, wherein the downlink compensation portion and the uplink compensation portion are selected to reduce or minimize variation of the at least one communication condition as seen by the terrestrial mobile device, and wherein reducing or minimizing the variation of the at least one communication condition as seen by the terrestrial mobile device comprises (1) reducing a rate of change of the variation, and/or (2) reducing a rate of change of a rate of change of the variation.

20. The non-transitory computer-readable storage medium of claim 17, wherein the downlink compensation portion and the uplink compensation portion have different magnitudes.
